(19) United States
(12) Patent Application Publication
(10) Pub. No.: US 2010/0236526 A1
(43) Pub. Date: Sep. 23, 2010

(54) Common rail electronic control injector

(75) Inventors: Yang Wang, Tianjin (CN); Xiao Zhang, Tianjin (CN); Tao Zhu, Tianjin (CN); Shuaiqing Xu, Tianjin (CN); Qian Xiong, Tianjin (CN); Mingfa Yao, Tianjin (CN); Qingyun Tian, Tianjin (CN); Fang He, Tianjin (CN); Zhong Zhang, Tianjin (CN)

Correspondence Address: ZHEN ZHENG LU, 1730 HUNTINGTON DRIVE #304, DUARTE, CA, 91010, US

(73) Assignee: Tianjin University

(21) Appl. No.: 12/714,554

(22) Filed: Mar. 1, 2010

(30) Foreign Application Priority Data
Mar. 20, 2009 (CN) 200910068199.0

(51) Int. Cl. F02M 69/46; F02M 51/00

(52) U.S. Cl. 123/456; 123/476

(57) ABSTRACT

The present invention relates to a common rail electronic control injector, which belongs to the electronic control fuel injection system technology. The injector includes an oil inlet joint, an oil inlet located at outside the oil inlet joint, an electromagnet device, a nozzle body, a needle valve, a valve seat and spray holes, wherein the electromagnet device includes a static core, an armature and a coil, wherein a working gap between the static core and the armature is H, the armature is moveably connected with the needle valve along an axial direction. The present invention further includes a compression spring applying a force to the needle valve, a force mechanism applying a force to the armature, and a block mechanism providing an axial anti-thrust while the armature is reset. The present invention has advantages of lower manufacturing cost, better reliability and smaller driving energy.

### BACKGROUND OF THE PRESENT INVENTION

1. Field of Invention

The present invention relates to a common rail electronic control injector, and more particularly to a common rail electronic control injector for a common rail type electronic control fuel injection system of a compression ignition engine (diesel).

2. Description of Related Arts

The function of the common rail electronic control injector is to control the injection's start and end of the injector by using electrical pulse signals. The existing technology, such as the common rail electronic control injectors for the CR system of BOSCH Corporation, the ECD-U2 system of Japan's DENSO Corporation, the UNIJET system of Italian FIAT Group, the LDCR system of British DELPHI DIESEL SYSTEMS Corporation, has common characteristics that it comprises a solenoid valve and a control room controlled by the solenoid valve, the electromagnetic force firstly controls a switch action of the solenoid valve for changing the pressure of the control room so as to change the hydraulic pressure of hydraulic piston or the hydraulic pressure of the upper end surface of needle valve, and controls the lift or drop of the needle valve at the end. The technology mentioned above has several shortcomings as follows: 1. There are many control links, the electromagnetic force is transformed firstly to the spool displacement of the solenoid valve, and secondly to the pressure of the control room, and thirdly to the displacement of needle valve, thus resulting in difficult control for dimension chain, high manufacturing cost and decreased reliability. 2. There are many dynamic sealing links, the hydraulic piston or the external cylindrical surface of the needle valve has the requirement of dynamic sealing, thus resulting in leakage losses and there being deadlock fault sources. 3. During the process of releasing the control room pressure, the solenoid valve will discharge a considerable proportion of high-pressure fuel, along with the leakage losses of the dynamic sealing links, thus resulting in low utilization rate of energy. 4. The injector must have an oil return port for collecting the oil return of the control room and leakage fuels of the dynamic sealing links, thus the pipeline layout is complex.

On the other hand, the electronic control injector currently used for gasoline engine comprises the port injection and in-cylinder direct injection valve, its working principle is that pulling directly the needle valve by electromagnets to achieve injection process control, thus it has advantages of smaller control links and dynamic sealing links, no oil return port, and higher energy efficiency. However, the electromagnetic forces of electromagnets are limited, so the electronic control injector herein is only adapted for some occasions with lower injection pressure (smaller than 120 bar), and can not be used for the fuel injection system diesel.

### SUMMARY OF THE PRESENT INVENTION

An object of the present invention is to provide a common rail electronic control injector for the compression-ignition internal combustion engine, which is capable of overcoming the above mentioned shortcomings of current common rail electronic control injectors, absorbing benefits of current gasoline electronic control injectors, so that the common rail electronic control injector has advantages of smaller control links and dynamic sealing links, higher energy efficiency and no oil return.

The above mentioned object is achieved by the following working principle and the design.

The principle of operation uses a physical phenomenon in this invention: when one moving object rigidly impacts the other stationary object, a great impact force will be produced in a short time, thus the present invention takes advantage of the physical phenomena to achieve the amplification of electromagnetic force. The specific approach is: firstly, the armature has a certain speed and kinetic energy by the electromagnetic force, and then impacts the needle valve of the injector at a stationary state, the resultant force of impact forces generated by the impact and electromagnetic forces is applied to overcome the hydraulic pressure so as to open the needle valve. Once the needle valve is open, the hydraulic pressure will rapidly decrease to near 0, here the electromagnetic force can maintain the open state of the needle valve just by overcoming the reset spring force of the needle valve.

The design is illustrated as follows:

A common rail electronic control injector comprises an oil inlet joint, an oil inlet located at an outer end of the oil inlet joint, an electromagnet device, a nozzle body, a needle valve, a valve seat and spray holes, is characterized in that the electromagnet device comprises a static core, an armature and a coil, wherein a working gap between the static core and the armature is H.

This invention is characterized in that the armature is moveably connected with the needle valve along an axial direction, wherein a distance “h” along the axial direction is formed at a power-off reset state of the electromagnet device. After the electromagnet device is power-on, the armature firstly approaches the needle valve, secondly impacts the needle valve, and moves towards the static core together with the needle valve at last.

The invention further comprises a compression spring applying a downward reset force to the needle valve, a force mechanism applying a downward reset force to the armature, and a block mechanism providing an axial anti-thrust while the armature is reset.

As a preferred embodiment for achieving the impact process between the armature and the needle valve, the needle valve is designed to be T-shaped, a flange is located at an upper portion of the needle valve, a lower end surface of the flange is defined as a first impact surface “a”, a shoulder hole is located at the middle of the armature, a scapular plane is located at a transition of the shoulder hole, the scapular plane is defined as a second impact surface “b”, responding to the first impact surface “a”, a distance “h” is between this two impact surfaces at the power-off reset state of the electromagnet device. After the electromagnet device is power-on, the first impact surface “a” will impact the second impact surface “b”.

As a preferred embodiment of the electromagnet device, the electromagnet device further comprises: an upper concentrating flux sleeve located at a periphery of the static core, a lower concentrating flux sleeve located at a periphery of the armature, a magnetic shield located between the upper concentrating flux sleeve and the lower concentrating flux sleeve, and a casing located at a periphery of the coil. The static core, the upper concentrating flux sleeve, the casing, the lower concentrating flux sleeve, the armature, and the working gap H are connected in series in turn, thus a closed loop magnetic circuit around the coil is formed.

As a preferred embodiment of the armature reset force mechanism, the force mechanism comprises a permanent magnet fixedly mounted on an upper portion of the nozzle body, wherein an upper end surface of the permanent magnet is located at below the armature and is corresponding to a lower end surface of the armature.

As a preferred embodiment of the armature reset block mechanism, a ring-shaped block surface is located on an upper end surface of the nozzle body which is located below the armature.

By using new working principles and structures described above, the limited electromagnetic force generated by the electromagnet is amplified by the impact principle, and the needle valve is directly driven to move without going through the hydraulic control links, thus the control links are decreased. No plunger matching portions are needed within the injector, and the dynamic sealing links only include the needle valve and valve seat, resulting in that the dynamic sealing links are reduced to a minimum level. Since the absence of the oil return of the control room and the leakage losses of the plunger matching portions exist, higher energy efficiency of the system can be made. No oil return ports are needed in the injector due to the reasons mentioned above.

The ultimate expression of the advantages mentioned above is: the common rail electronic control injector of the present invention has advantages of lower manufacturing cost, better reliability and smaller driving energy.

These and other objectives, features, and advantages of the present invention will become apparent from the following detailed description, the accompanying drawings, and the appended claims.

### BRIEF DESCRIPTION OF THE DRAWINGS

FIG. 1 is an axial sectional view of a common rail electronic control injector.

FIG. 2 is a sectional view of an armature along an A-A direction.

FIG. 3 is a sectional view of the armature along a B-B direction.

FIG. 4 is a sectional view of the armature along a C-C direction.

FIGS. 5 to 8 are measurement curves and pictures obtained through experiments while the common rail electronic control injector is used for the dimethyl ether fuel injection.

FIG. 5 is fuel injection law curves under different common rail pressures.

FIG. 6 is fuel injection rate curves responding to different driving pulse widths under different common rail pressures.

FIG. 7 is pre-injection fuel injection rate curves achieved by adjusting the driving pulse signals, illustrating that the pre-injection amounts and the interval between the pre-injection driving pulse and the main pulse can be controlled flexibly, by adjusting the width of pre-injection driving pulse, and the interval between the pre-injection driving pulse and the main pulse.

FIG. 8 is a spray image at different injection times during the pilot process.

### DETAILED DESCRIPTION OF THE PREFERRED EMBODIMENT

In combination with drawings, the structure and principle of a common rail electronic control injector are illustrated in detail as follows.

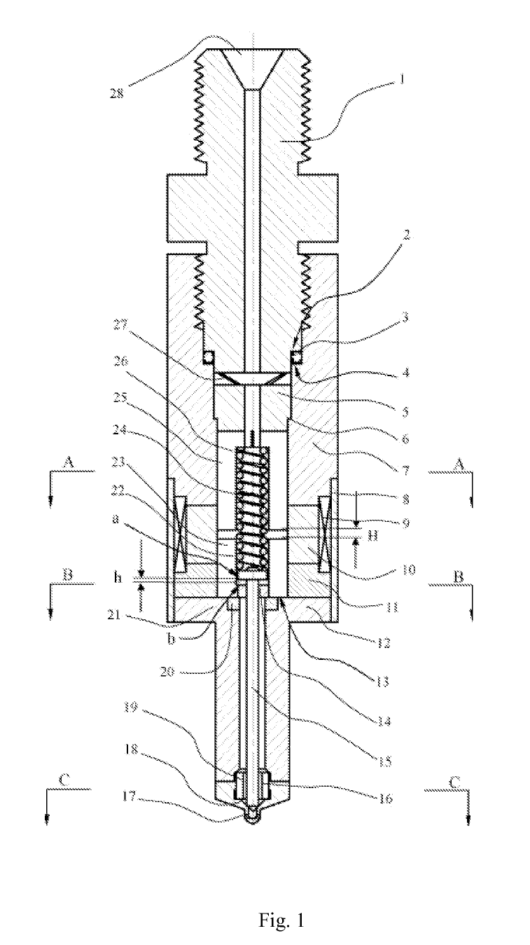

Referring to FIG. 1, the common rail electronic control injector comprises: a fuel inlet joint 1, a fuel inlet 28 located at an outer end of the fuel inlet joint 1, an electromagnet device, a nozzle body 12, a needle valve 15, a valve seat 18 and spray holes 17. The electromagnet device comprises a static core 5, an armature 14, wherein a working gap “H” is formed therebetween, and a coil 9.

The armature 14 is moveably connected with the needle valve 15 along an axial direction. A distance “h” is between the armature 14 and the needle valve 15 along the axial direction at a power-off reset state of the electromagnet device. After the electromagnet device is power-on, the armature 14 firstly closes to the needle valve 15, secondly impacts the needle valve 15, and moves towards the static core 5 together with the needle valve 15 at last.

The present invention further comprises a compression spring 24 applying a downward reset force to the needle valve 15, a force mechanism applying a downward reset force to the armature 14, and a block mechanism providing an axial anti-thrust while the armature 14 is reset.

The impact mechanism of the armature and the needle valve in the present invention is illustrated as follows. The needle valve 15 is designed to be T-shaped, a flange is located at an upper portion of the needle valve, a lower end surface of the flange is defined as a first impact surface “a”, a shoulder hole 22 is located at the middle of the armature 14, a scapular plane is located at a transition of the shoulder hole 22, and is defined as a second impact surface “b” responding to the first impact surface “a”. A distance “h” is between these two impact surfaces at the power-off reset state of the electromagnet device. After the electromagnet device is power-on, the first impact surface “a” will impact the second impact surface “b”. Other impact structures can also be selected, for example: the shape of the flange of the needle valve is constant with its position moving upwards, the shoulder hole 22 becomes a cylindrical hole cooperating with the needle valve 15, and the second impact surface “b” is located at a top surface of the armature 14. A circular groove is located at an upper portion of the needle valve. An elastic clamp spring is located within the circular groove, and a convex portion of the clamp spring will take place of the function of the flange. Furthermore, the impact function mentioned above can also be achieved by mounting a dowel intersecting perpendicularly with an axis on the armature and designing a long groove cooperating with the dowel on the needle valve.

As shown in FIG. 1, besides the static core 5, the armature 14, the coil 9, and the working gap H between the static core 5 and the armature 14, the electromagnet device further comprises: an upper concentrating flux sleeve 7 located at a periphery of the static core 5, a lower concentrating flux sleeve 11 located at a periphery of the armature 14, a magnetic shield 10 located between the upper concentrating flux sleeve 7 and the lower concentrating flux sleeve 11, and a casing 8 located at a periphery of the coil 9, wherein the static core 5, the upper concentrating flux sleeve 7, the casing 8, the lower concentrating flux sleeve 11, the armature 14, and the working gap “H” are connected in series in turn, so a closed loop magnetic circuit around the coil 9 is formed. In FIG. 1, a pair of pull-in surfaces between the armature and the static core is a pair of planes. In addition, the stepped surfaces or conical surfaces for the large-travel electromagnet can also be used. In addition to the solutions mentioned above, the electromagnet device can also adopt other structures, currently known by the public, for example: the armature is designed to be a discal bacterium-shaped electromagnet structure without the magnetic shield.

As shown in FIG. 1, the force mechanism for providing armature reset comprises a permanent magnet 20 fixedly mounted on an upper portion of the nozzle body 12, wherein an upper end surface of the permanent magnet 20 is located below the armature 14 and is corresponding to a lower end surface of the armature. The permanent magnet 20 mentioned above is circular, an axis thereof coincides with an axis of the armature 14, and a polarization direction of the permanent magnet is axial. The force mechanism can also adopt other forms, for example: the permanent magnet is mounted to a bottom of the armature. The ring-shaped block surface 13 located below the armature is magnetized to produce the magnetic force. A compression spring is added between the static core and the armature for applying a downward force to the armature.

Referring to FIG. 1, the block mechanism for the armature reset anti-thrust, is a ring-shaped block surface 13 provided at an upper end surface of the nozzle body and located below the armature 14. It also can adopt other forms, for example: a scapular plane is provided on the needle valve, when the armature moves to the reset position, the scapular plane will contact with the bottom of the armature to achieve the anti-thrust function.

Referring to FIG. 1, a spring hole 26 is located at the middle of the static core 5 with its upper end communicating with the fuel inlet 28. An upper portion of the compression spring 24 is mounted within the spring hole 26. A lower portion of the compression spring 24 is mounted within the shoulder hole 22 located in the middle of the armature 14, and contacts with an upper end surface of the flange of the needle valve 15.

In the preferred embodiment mentioned above, the magnetic shield 10 is made of non-magnetic materials, such as non-magnetic stainless steel or non-magnetic titanium alloy. The magnetic shield 10 is connected with the upper concentrating flux sleeve 7 and the lower concentrating flux sleeve 11 by welding, respectively. The upper end surface of the nozzle body 12 is connected with the lower end surface of the lower concentrating flux sleeve 11 by welding, and the lower end surface of the nozzle body 12 is connected with the upper end surface of the valve seat 18 by welding. If the diameter size of the injector allows larger cases, the above combination surfaces needing welding can also adopt the flat seal, screw locking cap tightly pressed connection of conventional injectors.

As shown in FIG. 1, the static core 5 is a T-shaped cylinder with a flange at the upper portion thereof, while its external cylindrical surface closely contacts with an inner surface of the upper concentrating flux sleeve 7. A lower end surface 6 of the flange of the static core 5 contacts with the scapular plane corresponding with the upper concentrating flux sleeve 7, while a compression spring 27 is located between the upper end surface of the static core 5 and a lower end surface of the fuel inlet joint 1, wherein the compression spring 27 can be a dishing compression spring. As described above, the design has the advantage of better assembly manufacturability.

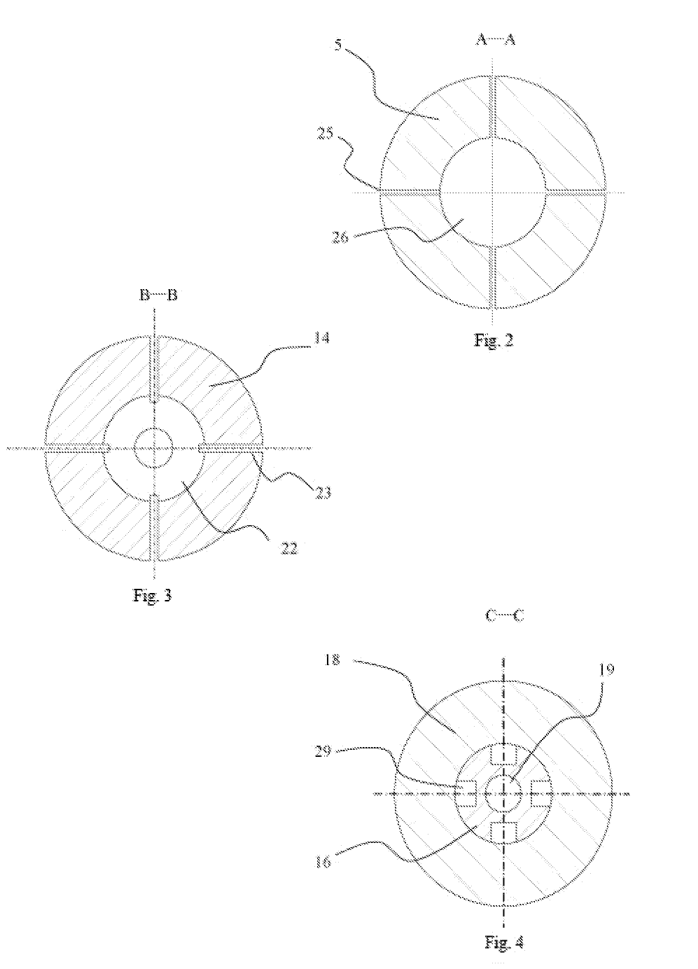

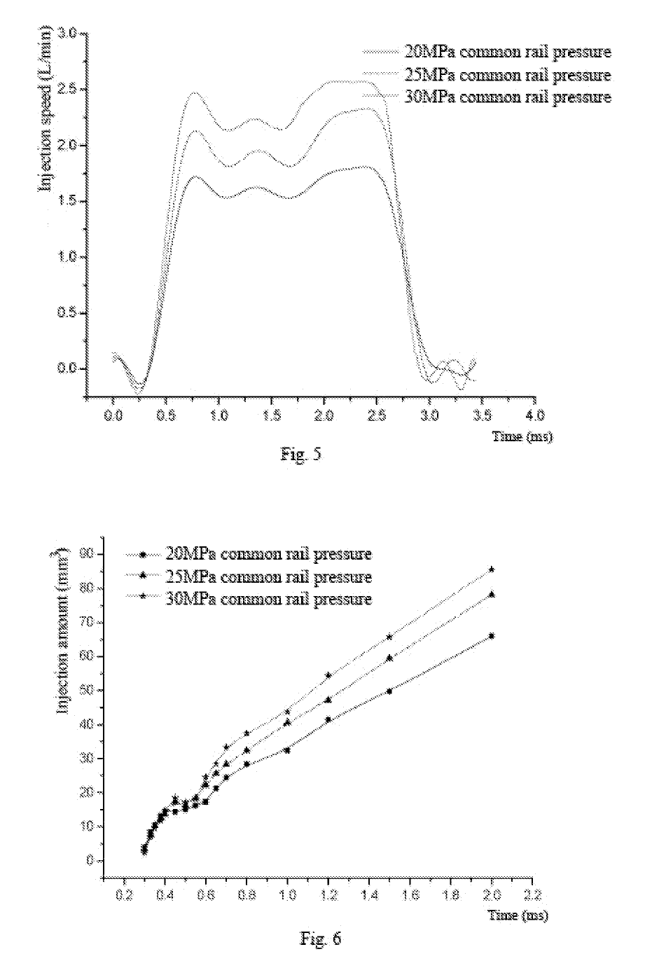

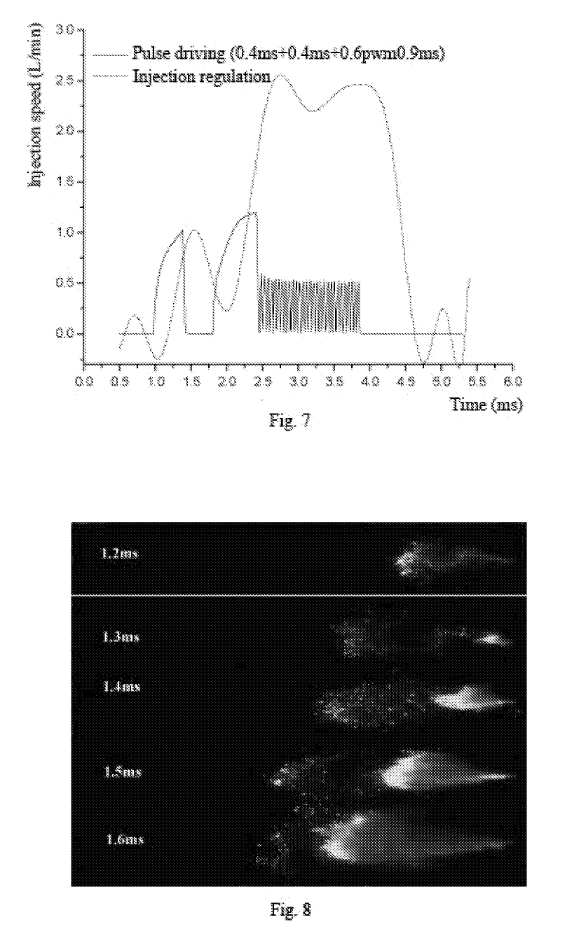

In order to reduce electric eddy current losses, further improve the electromagnetic response speed of the injector, increase the fuel flow area and reduce the flow resistance, referring to FIGS. 1 and 2, a plurality of narrow grooves 25 are located within the static core 5, and the narrow grooves 25 are radially distributed around an axis of the static core 5. For the same purpose, referring to FIGS. 1 and 3, a plurality of narrow grooves 23 are provided within the armature 14, the narrow grooves 23 are radially distributed around an axis of the armature 14.

In order to improve the working life of injector, the upper end surface and external cylindrical surface of the armature 14, and the lower end surface of the static core 5 are coated with wear-resistant non-magnetic coating. The coating can not only increase wear-resistance but improve the power-off releasing speed of the armature 14. For achieving the above object, a magnetic isolation gasket is mounted on the lower end surface of the static core 5 or the upper end surface of the armature 14.

For improving the cooperation of the needle valve and valve seat, a needle valve guiding sleeve 16 is mounted closely to the valve seat 18, a circular hole 19 sliding fit with the needle valve 15 is located at the center of the needle valve guiding sleeve 16, a plurality of circulating slots 29 are located at outside the needle valve guiding sleeve 16, thus the fuel can flow smoothly across the circulating slots 29 to reach the vicinity of the valve seat. An axis of the circular hole 19 is coincident with that of the valve seat 18. Of course, a plurality of circulating apertures can be selected instead of the circulating slots 29.

As shown in FIG. 1, the fuel inlet joint 1 is screw slip-join mounted to the upper concentrating flux sleeve 7, a circular space is provided between a scapular plane 2 located at a lower portion of the fuel inlet joint 1, and a scapular plane 4 of the upper concentrating flux sleeve 7, a sealing ring 3 is located within the circular space. The sealing ring 3 can be made of metal or plastic material with a predetermined deformability and strength, such as any one of copper, aluminium alloy, polytetrafluoroethylene, and nylon. The advantage of the fuel inlet joint is that the installation and maintenance is easy, furthermore the fuel inlet joint 1 and the upper concentrating flux sleeve 7 can be connected by welding or be made.

The working principle of the above-mentioned common rail electronic control injector is illustrated as follows:

In the initial state: the electromagnetic coil 9 is power-off, the armature 14 is attracted by the permanent magnet 20 for keeping the attaching state with an anti-thrust surface 13, and the distance “H” is between the upper end surface of the armature 14 and the lower end surface of the static core 5. Under the effect of the compression spring 24 and internal hydraulic pressure, the needle valve 15 keeps a sealing state with the valve seat 18, and the injector does not inject. The distance “h” herein, which is defined as a free lift, is between the second impact surface “b” on the armature 14 and the first impact surface “a” on the needle valve.

In the injection process: the electromagnetic coil 9 is power-on, the armature 14 suffers an upward magnetic attraction, and thus it overcomes the attraction of the permanent magnet 20 to move upwards. The armature 14 will obtain a certain kinetic energy during the process. During the movement, a distance between the second impact surface “b” of the armature 14 and the first impact surface “a” of the needle valve reduces from h to 0, while a distance between the armature and the static core is H-h, defined as effective lift. The two impact surfaces impact fittingly, and the kinetic energy stored in the armature and the magnetic attraction suffered by the armature are transformed to an upward thrust applied to the needle valve 14, when the needle valve 14 overcomes the resultant force of the elasticity of the compression spring 24 and the hydraulic pressure to be put up, the injection process will start. The armature 14 drives the needle valve 15 to continue moving upwards, the hydraulic pressure applied to the needle valve 15 will reduce rapidly, the effective lift will reduce from H-h to 0, and the needle valve is open to the maximum.

In the stop injection process: the electromagnetic coil 9 is power-off, the magnetic attraction suffered by the armature 14 is reduced, the needle valve 15 will drive the armature 14 to move downwards under the downward elasticity of the compression spring 24, and a distance between the needle valve 15 and the valve seat 18 will reduced to 0, so that the injection is stopped; and the armature 14 is departed from the needle valve 15, and continues to move downwards under the inertia and the attraction of permanent magnet 20 till attaching to the anti-thrust surface 13, now the injector returns to the reset state.

The common rail electronic control injector of the present invention can be applied to the diesel fuel injection system with the injection pressure of more than 1000 bar. Because there is no plunger seal links and no fuel return port within the injector, it is also particularly suitable for dimethyl ether, liquefied petroleum gas and other low-viscosity fuel common rail injection system. The present invention can also be extended for the direct injection system of the natural gas engine.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A common rail electronic control injector, comprising: an oil inlet joint, an oil inlet located at an outer end of said oil inlet joint, an electromagnet device, a nozzle body, a needle valve, a valve seat and spray holes, wherein said electromagnet device comprises a static core, an armature and a coil, a working gap between said static core and said armature is H,
wherein said armature is moveably connected with said needle valve along an axial direction, a distance between said armature and said needle valve along said axial direction is h at a power-off reset state of said electromagnet device, wherein after said electromagnet device is power-on, said armature firstly approaches said needle valve, secondly impacts said needle valve, and moves towards said static core together with said needle valve at last,
further comprising a compression spring directly applying a downward reset force to said needle valve, a force mechanism directly applying a downward reset force to said armature, and a block mechanism providing an axial anti-thrust while said armature is reset.

2. The common rail electronic control injector, as recited in claim 1, wherein said needle valve is T-shaped, a flange is located at an upper portion of said needle valve, a lower end surface of said flange is defined as a first impact surface, a shoulder hole is located at the middle of said armature, a scapular plane is located at a transition of said shoulder hole, said scapular plane is defined as a second impact surface responding to said first impact surface, wherein a distance between said first impact surface and said second impact surface is h at a power-off reset state of said electromagnet device, after said electromagnet device is power on, said first impact surface will impact said second impact surface.

3. The common rail electronic control injector, as recited in claim 1, wherein said electromagnet device further comprises: an upper concentrating flux sleeve located at a periphery of said static core, a lower concentrating flux sleeve located at a periphery of said armature, a magnetic shield located between said upper concentrating flux sleeve and said lower concentrating flux sleeve, and a casing located at a periphery of said coil, wherein said static core, said upper concentrating flux sleeve, said casing, said lower concentrating flux sleeve, said armature, and said working gap H are connected in series in turn so a closed loop magnetic circuit around said coil is formed.

4. The common rail electronic control injector, as recited in claim 3, wherein said magnetic shield is made of non-magnetic stainless steel or non-magnetic titanium alloy, said magnetic shield is connected with said upper concentrating flux sleeve and said lower concentrating flux sleeve by welding, respectively.

5. The common rail electronic control injector, as recited in claim 3, wherein an upper end surface of said nozzle body is connected with a lower end surface of said lower concentrating flux sleeve by welding, and a lower end surface of said nozzle body is connected with an upper end surface of said valve seat by welding.

6. The common rail electronic control injector, as recited in claim 3, wherein said static core is a T-shaped cylinder with a flange at an upper portion thereof, an external cylindrical surface of said static core closely contacts with an inner surface of said upper concentrating flux sleeve, a lower end surface of said flange of said static core contacts with corresponding scapular plane on said upper concentrating flux sleeve, a compression spring is provided between an upper end surface of said static core and a lower end surface of said fuel inlet joint.

7. The common rail electronic control injector, as recited in claim 6, wherein said compression spring is a dishing compression spring.

8. The common rail electronic control injector, as recited in claim 1, wherein said force mechanism comprises a permanent magnet fixedly mounted on an upper portion of said nozzle body, wherein an upper end surface of said permanent magnet is located below said armature and is corresponding to a lower end surface of said armature.

9. The common rail electronic control injector, as recited in claim 8, wherein said permanent magnet is circular, an axis thereof coincides with an axis of said armature, and a polarization direction of said permanent magnet is axial.

10. The common rail electronic control injector, as recited in claim 1, wherein said block mechanism is a ring-shaped block surface located at an upper end surface of said nozzle body and located below said armature.

11. The common rail electronic control injector, as recited in claim 2, wherein a spring hole is located at the middle of said static core, an upper end of said spring hole communicates with said fuel inlet, an upper portion of said compression spring is mounted within said spring hole, a lower portion of said compression spring contacts with an upper end surface of said needle valve.

12. The common rail electronic control injector, as recited in claim 2, wherein a plurality of narrow grooves are located within said static core, said narrow grooves are radially distributed around an axis of said static core, wherein a plurality of narrow grooves are provided within said armature, and said narrow grooves are radially distributed around an axis of said armature.

13. The common rail electronic control injector, as recited in claim 2, wherein an upper end surface and external cylindrical surface of said armature, and a lower end surface of said static core are coated with a wear-resistant non-magnetic coating.

14. The common rail electronic control injector, as recited in claim 2, wherein a needle valve guiding sleeve is mounted closely to said valve seat, a circular hole sliding fit with said needle valve is located at the center of said needle valve guiding sleeve, a plurality of circulating slots are located at outside said needle valve guiding sleeve, an axis of said circular hole coincides with that of said valve seat.

15. The common rail electronic control injector, as recited in claim 2, wherein said fuel inlet joint is screw slip-join, mounted to said upper concentrating flux sleeve, a circular space is provided between a scapular plane located at a lower portion of said fuel inlet joint, and a scapular plane of said upper concentrating flux sleeve, a sealing ring is located within said circular space.

16. The common rail electronic control injector, as recited in claim 3, wherein a spring hole is located at the middle of said static core, an upper end of said spring hole communicates with said fuel inlet, an upper portion of said compression spring is mounted within said spring hole, a lower portion of said compression spring contacts with an upper end surface of said needle valve.

17. The common rail electronic control injector, as recited in claim 3, wherein a plurality of narrow grooves are located within said static core, said narrow grooves are radially distributed around an axis of said static core, wherein a plurality of narrow grooves are provided within said armature, and said narrow grooves are radially distributed around an axis of said armature.

18. The common rail electronic control injector, as recited in claim 3, wherein an upper end surface and external cylindrical surface of said armature, and a lower end surface of said static core are coated with a wear-resistant non-magnetic coating.

19. The common rail electronic control injector, as recited in claim 3, wherein a needle valve guiding sleeve is mounted closely to said valve seat, a circular hole sliding fit with said needle valve is located at the center of said needle valve guiding sleeve, a plurality of circulating slots are located at outside said needle valve guiding sleeve, an axis of said circular hole coincides with that of said valve seat.

20. The common rail electronic control injector, as recited in claim 3, wherein said fuel inlet joint is screw slip-join, mounted to said upper concentrating flux sleeve, a circular space is provided between a scapular plane located at a lower portion of said fuel inlet joint, and a scapular plane of said upper concentrating flux sleeve, a sealing ring is located within said circular space.
